(19) United States
(12) Patent Application Publication
(10) Pub. No.: US 2018/0147753 A1
(43) Pub. Date: May 31, 2018

(54) METHOD FOR PRODUCING A MULTILAYER PIPE CONTAINING MICROFIBERS, AND SUCH A PIPE

(71) Applicant: Amiblu Holding GmbH, Klagenfurt (AT)

(72) Inventor: Thomas Simoner, Maria Saal (AT)

(73) Assignee: Amiblu Holding GmbH, Klagenfurt (AT)

(21) Appl. No.: 15/578,910

(22) PCT Filed: Feb. 16, 2016
(86) PCT No.: PCT/EP2016/053208

§ 371 Date: Dec. 1, 2017

(30) Foreign Application Priority Data
Jun. 9, 2015 (EP) 15171190.0

(51) Int. Cl. B29C 41/04; B29C 41/52; B29C 70/32; B29C 70/02; F16L 9/12

(52) U.S. Cl. CPC B29C 41/042; B29C 41/52; B29L 2023/22; B29C 70/025; F16L 9/121; B29C 70/326

(57) ABSTRACT

A method for producing a multilayer pipe with an outer layer which forms a pipe outer contour, an inner layer which forms a pipe inner contour, and at least one intermediate layer by means of a centrifugal casting process. A mixture of resin and microfibers is supplied to a rotating die in order to form the inner layer, and a specified separation of the resin and the microfibers is produced by controlling the die rotational speed during a specified time such that the content of the microfibers in a boundary layer, which starts from the pipe inner contour, is lower than the content in a stability layer facing the intermediate layer. The invention likewise relates to a corresponding multilayer pipe.

The present invention relates to a method for producing a pipe according to claim 1 and to a pipe according to claim 6.

EP 0360758 B1 discloses a method for producing pipe sections made of plastic, inorganic filler, and glass fibers in a centrifugal casting method, as well as a pipe section produced according to this method. Inner layers are designed as practically pure resin layers, so that the pipe walls are made as smooth as possible.

The object of the present invention is to design a pipe that is as stable as possible with an inner pipe contour that is as smooth as possible.

This object is achieved with the features of patent claims 1 and/or 6, wherein further advantageous developments of the invention are indicated in the dependent claims. All combinations of at least two of the features indicated in the description, the claims, and/or the figures fall within the scope of the invention. In the specified value ranges, values which lie within the indicated limits will also be disclosed as boundary values and may be claimed in any combination.

The invention is based on the idea that during production/deposition of the inner layer on the intermediate layer(s), the inner layer is to be mixed with microfibers that are to be separated from the pipe inner contour during deposition, especially by means of centrifugal acceleration.

In particular, the present invention relates to a method for producing a multilayer pipe with an outer layer forming a pipe outer contour, an inner layer forming a pipe inner contour, and at least one intermediate layer in the centrifugal casting method, wherein a mixture of resin and microfibers is supplied to a rotating die and by controlling the rotational speed of the die for a predetermined time, a predetermined separation of the resin and the microfibers is produced.

Thus producing the inner layer (also termed a liner layer) that closes off the pipe inwardly ensures on the one hand that the latter is smooth on the pipe inner contour (in particular due to the centrifugal forces and the different density of resin and microfibers in the mixture), but due to the implementation of microfibers at the same time has a high stability.

According to the invention in particular the following properties of the pipe, in particular in the region of the inner layer closing off the pipe inwardly, are improved:
improvement of shock resistance and/or
avoidance of cracks and/or
improvement of chemical resistance (CSS) and/or
improvement of inner pressure resistance due to the strengthening properties of the newly formed inner layer and/or
improvement of the ring deflection and/or
improvement of the processability of high-temperature resistant resins in the centrifugal method (avoidance of cracking during the production process) and/or
improvement in the diffusion density (barrier layer).

In a further development of the invention, the mixture has at least predominantly, in particular completely, microfibers with a length of less than 4000 μm, in particular less than 2000 μm, preferably less than 1000 μm, more preferably less than 250 μm, and still more preferably less than 125 μm.

Alternatively or additionally, the mixture has microfibers with an average length between 50 μm and 500 μm, in particular between 100 μm and 300 μm, preferably between 125 μm and 250 μm.

In this manner, the microfibers are optimally separated from the pipe inner contour by the centrifugal acceleration during pipe production, in that the microfibers, in particular with a density of 2500-2600 kg/m³, in particular at least during the rotation of the die have a higher density than the resin (in particular resin with a density of 1000 kg/m³ to 1200 kg/m³) and/or further components of the mixture.

According to an advantageous embodiment, the microfibers are formed at least predominantly, preferably completely from glass fibers. These are available in great quantities at a reasonable price, are easily processed, and have optimal physicochemical properties.

It is especially advantageous if the mixture has a content of 5% to 50%, in particular 10% to 45%, preferably 15% to 40% microfibers. In this range, an optimal separation can be achieved with simultaneous improvement in the physicochemical properties.

In addition the present invention also relates to a multilayer pipe with an outer layer forming a pipe outer contour, an inner layer forming a pipe inner contour, as well as at least one intermediate layer, wherein the inner layer is formed from resin and microfibers, and the content of the microfibers in an outer layer starting from the pipe inner contour is less than in a stability layer facing the intermediate layer.

In particular the inner layer (3) has a density d_{L} in particular between 0.1 mm and 5 mm, and the boundary layer (3g) a density d_{g} less than d_{L}/2, preferably less than d_{L}/4.

If features or value ranges are disclosed for the method, they must also be deemed disclosed for the pipe.

Further advantages, features, and properties of the invention follow from the description of preferable exemplary embodiments as well as with reference to the drawing. This shows in:

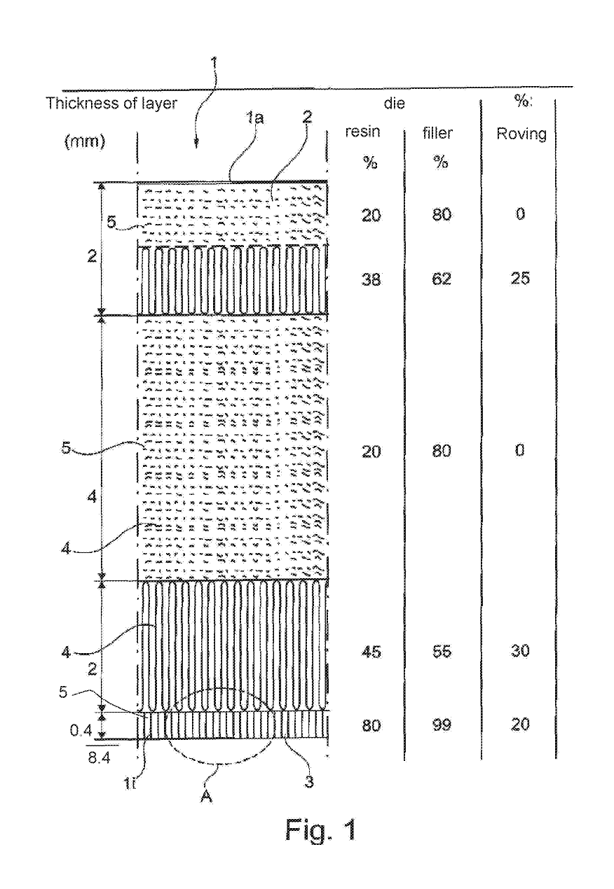

FIG. 1 a cross-sectional view of an embodiment of a wall of a pipe according to the invention

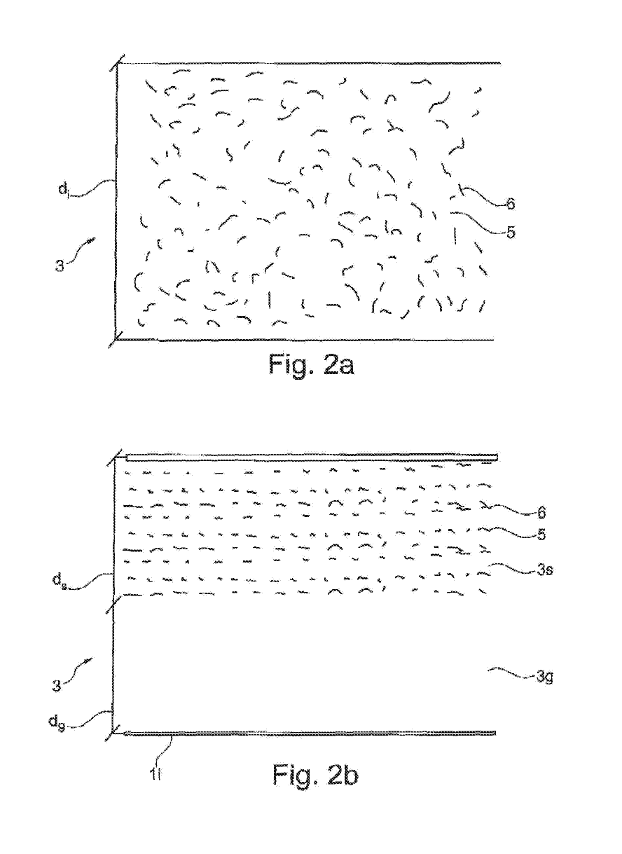

FIG. 2a an enlarged view A of the wall according to FIG. 1 upon deposition of an inner layer

FIG. 2b an enlarged view A of the wall according to FIG. 1 at separation.

Identical or identically acting components in the figures are marked with the same reference signs.

FIG. 1 gives an enlarged, sectional view of a pipe formed from several intermediate layers 4 and an outer layer 2 covering the intermediate layers 4 outwardly, and an inner layer 3 covering the intermediate layers 4 inwardly.

The intermediate layers 4 have different functions so as to stably form the pipe 1. They consist in part of resin, filler, and glass fibers called rovings.

The pipe 1 is made in a centrifugal method or centrifugal casting method as is basically described in EP 0 360 758 B1. With a die, the layers starting with the outer layer 2 via different intermediate layers 4 to the inner layer 3 are cast in a rotating die.

The material of the different layers is introduced via a lance to the die, wherein in each case a mixture of the components of the different layers is fed to the die. Examples of mixture ratios are given in FIG. 1 in percentages.

The special feature of the pipe 1 according to the embodiment lies in the introduction of the inner layer 3, which in contrast to the prior art is introduced as a mixture of resin 5 and microfibers 6. The microfibers 6 are arranged in the resin 5 such that initially they are arranged according to FIG. 2a in an equal distribution over the thickness dᵢ of the inner layer 3. By rotation of the die, a centrifugal force is produced, by which the microfibers 6 due to the higher density are separated in the inner layer, and the microfibers move in the direction of the outside of the pipe.

After a separation time, during which in particular the resin 5 also slowly hardens, a boundary layer 3g is formed, which is predominantly made of resin with a higher resin percentage than an adjoining stability layer 3s with a thickness dₛ. The stability layer 3s based on the plurality of microfibers 6, has a greater stability than the boundary layer 3g. The boundary layer 3g on the other hand at the tube inner contour 1i has an extremely smooth surface.

Thus the inner layer 3 in contrast to the previous inner layers 3 has better pipe properties with the effect that the pipe 1 generally can be made thinner.

The microfibers are designed as glass fibers. The mixture of microfibers 6 and resin 5 fed for the inner layer 3 via the lance has a mixture ratio of 1:2 (one part microfiber to two parts resin).

### LIST OF REFERENCE SIGNS

1 pipe
1i pipe inner contour
1a pipe outer contour
2 outer layer
3 inner layer
3g boundary layer
3s stability layer
4 intermediate layer(s)
5 resin
6 microfibers
d_{L} thickness of inner layer
d_{g} thickness of boundary layer
dₛ thickness of stability layer

1. A method for producing a multilayered pipe having an outer layer forming an outer pipe contour, an inner layer forming an inner pipe contour, and at least one intermediate layer, said method comprising a centrifugal casting process including:
forming the inner layer by feeding a mixture of resin and microfibers into a rotating die; and
separating the resin and the microfibers by controlling the rotational speed of the die during a predetermined time.

2. The method according to claim 1, wherein the mixture is at least predominantly comprised of microfibers having a length less than 4000 μm.

3. The method according to claim 1, wherein the mixture is comprised of microfibers having an average length between 50 μm and 500 μm.

4. The method according to claim 1, wherein the microfibers are at least predominantly formed from glass fibers.

5. The method according to claim 1, wherein the mixture contains an amount from 5% to 50% of microfibers.

6. A multilayered pipe comprising:
an outer layer forming an outer pipe contour;
an inner layer forming an inner pipe contour; and
at least one intermediate layer,
wherein the inner layer is formed from resin and microfibers, and the amount of the microfibers is lower in a boundary layer starting from the inner pipe contour than in a stability layer facing the intermediate layer.

7. The multilayered pipe according to claim 6, wherein the microfibers at least predominantly have a length less than 4000 μm.

8. The multilayered pipe according to claim 6, wherein the microfibers have an average length between 50 μm and 500 μm. cm 9. The multilayered pipe according to claim 6, wherein the microfibers are at least predominantly formed from glass fibers.

10. The multilayered pipe according to claim 6, wherein the inner layer contains an amount from 5% to 50%, of microfibers.

11. The multilayered pipe according to claim 6, wherein the inner layer has a thickness d_{L} between 0.1 mm and 5 mm, and the boundary layer has a thickness d_{g} less than d_{L}/2.
